(19) United States
(12) Patent Application Publication
(10) Pub. No.: US 2011/0307274 A1
(43) Pub. Date: Dec. 15, 2011

(54) INTEGRATED HEALTH CARE SYSTEM FOR MANAGING MEDICAL DEVICE INFORMATION

(75) Inventors: Paul R. THOMPSON, White Bear Lake, MN (US); Steven R. Kelly, Champlin, MN (US)

(73) Assignee: MEDTRONIC, INC., Minneapolis, MN (US)

(21) Appl. No.: 13/156,882

(22) Filed: Jun. 9, 2011

Related U.S. Application Data
(60) Provisional application No. 61/353,028, filed on Jun. 9, 2010.
(60) Provisional application No. 61/397,417, filed on Jun. 11, 2010.

(51) Int. Cl. G06Q 50/00; G06Q 10/00; G06F 9/44; G06Q 30/00

(52) U.S. Cl. 705/3; 705/2; 717/173

(57) ABSTRACT

Computer-implemented systems and methods for managing information include one or more client terminal devices in communication with a data interchange system. In one instance, the data interchange system may facilitate communication between a device manufacturer and a clinical site. One or more of the client terminals devices may be configured to: (a) collect the medical device information from the medical device; (b) transmit the medical device information to the medical device manufacturer and/or the clinical site via the interchange system; and (c) receive information from the medical device manufacturer and/or the clinical site via the interchange system. The client terminal device may be further configured to: (d) activate, deactivate or configure a medical device.

### CROSS REFERENCE TO RELATED APPLICATIONS

This application claims priority to U.S. Provisional Patent Application Ser. No. 61/353,028, filed on Jun. 9, 2010 and U.S. Provisional Patent Application Ser. No. 61/397,417, filed Jun. 11, 2010, the entire contents of each of which are incorporated herein by reference. This application is related to U.S. patent application Ser. No. 13/156,858, filed Jun. 9, 2011 (Attorney Docket No. 059022-0395151), which claims priority to U.S. Provisional Patent Application Ser. No. 61/353,028, filed on Jun. 9, 2010 and U.S. Provisional Patent Application Ser. No. 61/397,417, filed Jun. 11, 2010, the entire contents of each of which are incorporated herein by reference.

### FIELD OF INVENTION

This application generally relates to health care information management, and in particular, systems and methods for managing medical device and presenting patient information.

### BACKGROUND OF THE INVENTION

In the healthcare industry, various processes are typically performed by disparate information management systems and/or processes. These tasks may include, for instance, managing inventory, registering devices, enrolling customers, handling device returns, processing payments, ensuring proper medical therapy and updating electronic medical records (EMR) for patients. Some of these tasks are currently being performed in a manual and paper-laden manner. This can be very laborious and an inefficient use of resources (such as document storage and individuals). And, although, some tasks may be performed in a computerized or an automated manner, they are performed using multiple systems which store redundant data, require duplicitous data entry, and/or may not always be available to provide timely information. Thus, a better way for managing a medical device or patient device is desired.

### SUMMARY OF THE INVENTION

Systems and methods are disclosed for managing a medical or patient device information. In particular, a unified system is described which provides, among other things, automated data gathering, sharing of data, and transferring of collected data, which can reduce workload for personnel such as sales and back office personnel. In addition, the system can reduce processing costs by reducing workloads and duplicitous data entry, improve the timeliness of information retrieval, and improve traceability within a secure authenticated electronic data exchange environment.

According to an embodiment, a computer-implemented system for managing medical device and securely displaying patient data includes: at least one client terminal in communication with a secure data interchange system, the data interchange system being further in secure communication with a medical device manufacturer and/or a clinical site, wherein the client terminal is configured to: (a) collect the medical device information from the medical device; (b) transmit the medical device information securely to the medical device manufacturer and/or the clinical site via the interchange system; (c) receive information securely from the medical device manufacturer and/or the clinical site via the interchange system; (d) display patient data such as scheduled surgical procedures; (e) exchange patient data with consulting physicians such as during live consultations; (f) exchange device and patient information with local and global medical record systems through a decentralized networked data distribution system; (g) enable collaboration of device and patient data within shared medical environments such as used by emergency response teams, long term patient care facilities, primary care physicians, and large scale multisite medical facilities; and (h) run on commonly used computing environments The system may also be configured to (i) activate, deactivate or configure a medical device and to provide real-time patient tracking within a medical facility through monitoring of medical equipment and personnel interacting with the patient. The system may be geographically diverse and encompass one or multiple clinical sites.

According to an embodiment, a computer-implemented method for managing medical device information includes: providing a client terminal in communication with a data interchange system, the data interchange system in secure communication with a device manufacturer and/or a clinical site, wherein the client terminal is configured to: (a) collect the medical device information from the medical device; (b) transmit the medical device information to the medical device manufacturer and/or the clinical site via the interchange system; and (c) receive information from the medical device manufacturer and/or the clinical site via the interchange system. The method may also be configured to (d) activate, deactivate or configure a medical device. The communication received and transmitted by the interchange system may be authenticated in order to provide a secure system.

Other features of one or more embodiments of this disclosure will seem apparent from the following detailed description, and accompanying drawings, and the appended claims.

### BRIEF DESCRIPTION OF THE DRAWINGS

FIG. 1 depicts an overview of medical device use in accordance with an embodiment of the present invention.

FIG. 2 illustrates an exemplary system for managing medical device information in accordance with an embodiment of the present invention.

FIG. 3 illustrates an exemplary client terminal device in accordance with an embodiment of the present invention.

FIG. 4 illustrates an exemplary method system for managing medical device information in accordance with an embodiment of the present invention.

FIGS. 5-15 illustrate exemplary processes in accordance with various embodiments of the present invention for securely managing medical device and patient information.

### DETAILED DESCRIPTION OF THE INVENTION

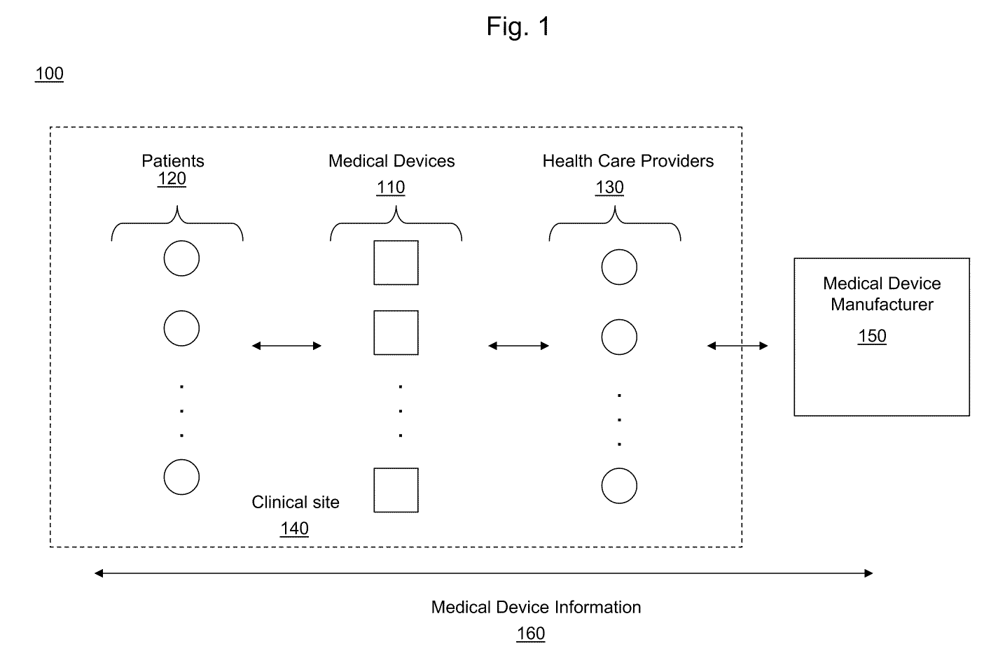

FIG. 1 depicts an overview 100 of medical device use in accordance with an embodiment of the present invention.

Medical devices 110 may include one or more products and/or devices which are intended for use by patients 120 and/or health care providers 130. For example, medical device 110 may be used for various purposes, such as, in diagnosis, monitoring, therapy, treatment, or surgery. Some devices 110 may be used externally, internally, or both by the patient 120 (generally as the nature of a particular medical device may dictate). Exemplary medical device 110 may include, but are not limited to: pacemakers, stents, coronary grafts, defibrillators (implantable or external), drug pumps and non-mechanical drug delivery systems, artificial valves, replacement joints, monitors, neurostimulators, prosthetics, etc. Some medical devices may be regulated by the Food and Drug Administration (FDA), and/or other government agencies. Others, though, may not.

Depending on the medical device 110 and treatment, the medical device 110 may have to be used, implanted, installed, configured, removed (explanted), etc. by the health care provider 130, at a clinical site 140, patient care facility, or remote location such as may be used by in-home therapy delivery professionals and emergency response individuals.

Health care providers 130 may include individuals (and organizations) that provide treatment services and general patient care. These may include, for example, physicians (such, as medical doctors, including surgeons, generalists, specialists, etc.), physician assistants, nurses, nurse practitioners, therapists, orderlies, paramedics, technicians, pharmacists, or other service provider. Health care providers 130 may be licensed or unlicensed professionals (depending on the treatment). In addition, health care providers may include support staff or other persons who do not actually perform treatment, such as billing agents, receptionists, managers, etc.

Clinical sites 140 are locations where treatment is generally performed and/or related to treatment, such as diagnosis, prevention, remedies, etc. A patient is an individual which receives treatment. Treatments may include professional services, for instance, but not limited to: medicine, pharmacy, psychology, dentistry, chiropractors, optometry, physical therapy, long term care facilities, etc. The clinical sites may include, for example, hospitals, doctor's and physician's offices, clinics, mobile clinics, laboratories, emergency response teams, and research centers, etc. In some instances, the clinical site might also include a patient's home or other location, for instance, if the a health care provider is on a “house call” or otherwise treating a patient away from a clinical site. The system described herein is not limited to a single clinical site, but may include multiple sites that may be geographically diverse from each other and that may communicate with each other through a network.

Medical devices 110 may be manufactured and/or supplied to the health care provider 130 by one or more medical device manufacturers 150. For ease of discussion, only one medical device manufacturer 150 is shown in FIG. 1. Medical device manufacturer 150 may be, for instance, any organization or entity which designs, manufactures, fabricates, builds, assembles, sells, distributes, repairs, and/or performs similar services for medical devices. One exemplary medical device manufacturer 150 is Medtronic Inc.

At the various interfaces between the patient 120, health care provider 130, clinical site 140 and/or medical device manufacturer 150, medical device information 160 may be generated, collected and/or processed, as described herein. Other events may also generate, collect and/or process medical device information 160. According to one or more embodiments described herein, the secure tracking and management of medical device information 160 and patient data may be simplified.

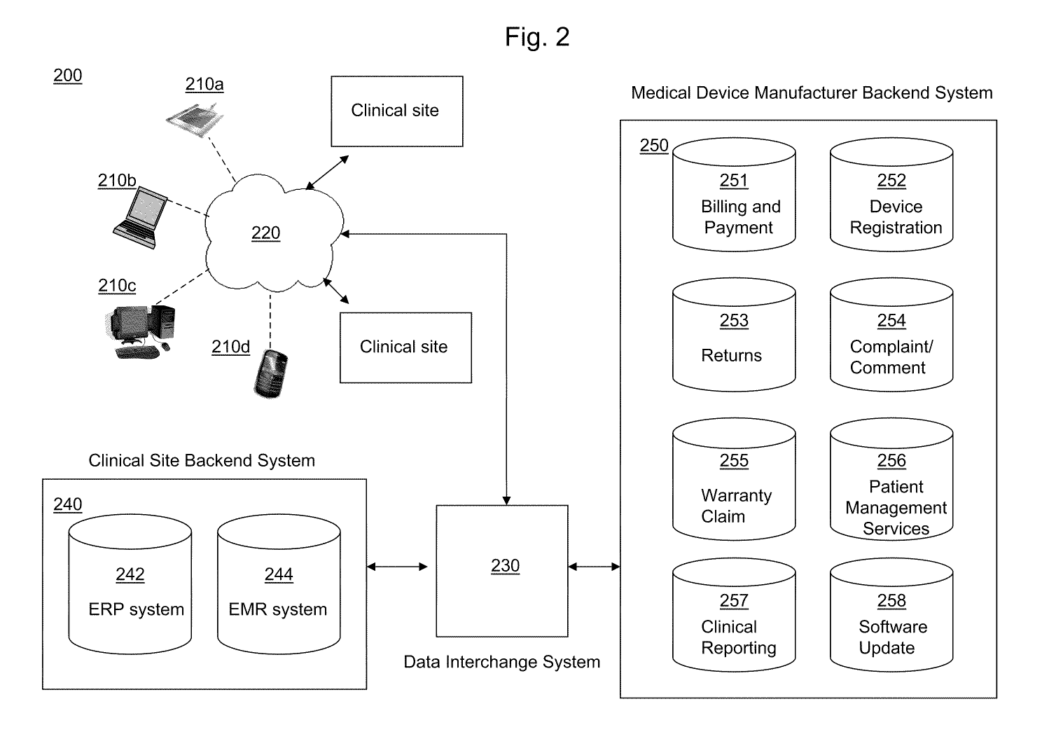

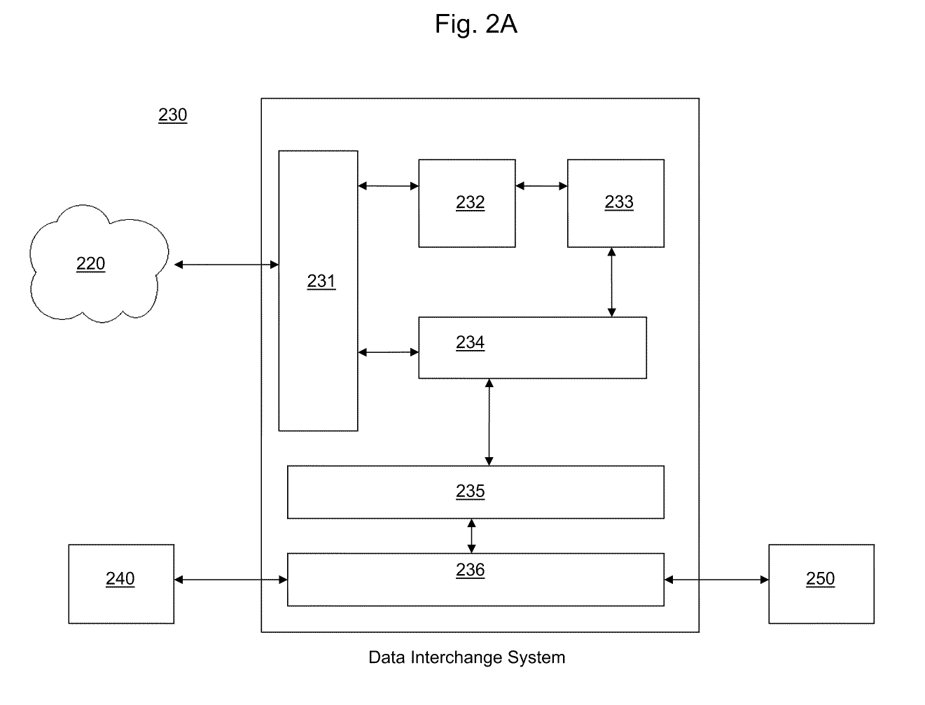

FIG. 2 illustrates an exemplary system 200 for tracking and managing medical device information in accordance with an embodiment of the present invention.

In the system 200, one or more users are in communication with a secure data interchange system 230 via client terminal devices 210a-210d. The client terminal devices may be located at a clinical site or another location, such as a home of one of the users. Users may include health care providers 130 at one or more clinical site 140 (FIG. 1). In some embodiments, authenticated sales representative of the medical device manufacturer 150 may also be users.

Medical device and patient information 160, which may be tracked and securely managed using the system 200 may include, for instance, information related to a medical device itself, as well as patient information, event information, healthcare provider information, clinical site information, and software/programming information in connection therewith.

Users may be remote from data interchange system 230, such that client terminals 210a-210d and data interchange system 230 transmit and receive secure data via local and global medical record systems through a decentralized networked data distribution system 220. The networked system 220 may include any one or more of, for example, the Internet, an intranet, Local Area Network (LAN), Wide Area Network (WAN), telephone, cellular, radio networks, or wireless networks, etc. Although, users may, additional or alternatively, interface with data interchange system 230 directly. The interface may include an authentication process that ensures secure communication with the data interchange system.

The client terminal devices 210 may include communication devices linked to the data interchange system 230. These devices 210 may be fixed and/or mobile to provide users with point-of-use convenience.

Fixed client terminals may be installed at one or more locations within a clinical site 140, and are not intended to be easily moved. These may include personal computers, electronic records shelving and management systems which automatically track the placement of medical devices therein, mounted scanning devices, data collection systems able to wirelessly interface and other data exchange devices. Fixed client terminals may be installed in locations around one or more clinical sites. This may include, for example, triage, surgical rooms, examination rooms, laboratory rooms, inventory supply rooms, reception areas, billing/record departments, or other locations. Clinical sites 140 may be differently configured (i.e., having more or less units).

In other embodiments, mobile client terminal devices may be generally small and portable, so as to be easily transported. This may give users the ability to carry the client terminals throughout the clinical site 140 and external to clinical sites such as by emergency response individuals and mobile therapy providers. Mobile client terminals devices may include, for instance, a smart phone, a personal digital assistant (PDA), a handheld computer, tablet computer, notebook computer or laptop computer, specialized device, a cart-based computing system (e.g., a SmaryCart™ sold by EarthWalk Communications, Inc.) or other mobile-, hand-held or portable devices. In some embodiments, a computerized inventory management transport system such as, for example, a WaveMark Mobile™ field inventory management device (sold by Wavemark Inc.) may be used.

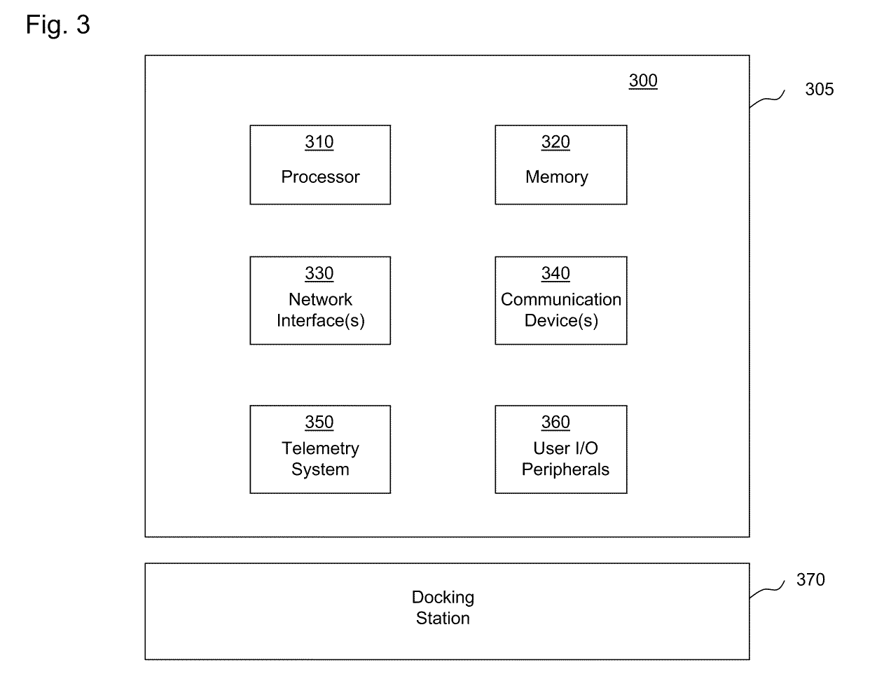

FIG. 3 shows one exemplary client terminal device 300 according to an embodiment of the present invention.

As further shown in FIG. 2A, the data interchange system 230 may include various modules 231-236. For instance, the data interchange system 230 may include a portal or network interface module 231, a transaction queue module 232, business rules module 233, notifications module 234, interface module 235 and data transfer module 236. One or more of the modules may be combined. For some purposes, not all modules may be necessary.

In one implementation, the data interchange system 230 may be one or more server systems hosted at medical device manufacturer 150 (FIG. 1). Although, it may be appreciated that the data interchange system 230 could be hosted at a clinical site 140, or by a third party.

According to some implementations, the data interchange system 230 may include dedicated hardware, such as, an application specific integrated circuit (ASIC) or field programmable gate array (FPGA), software (firmware), or a combination of dedicated hardware and software.

Some references herein are made to Medtronic, Inc.'s products and services. Of course, it will be appreciated that any number of hardware and/or software implementations, programming languages, and/or operating platforms may be used. As such, the description or recitation of any specific hardware or software implementation, programming language, database language, and operating platform herein is exemplary only and should not be viewed as limiting. For the different implementations disclosed herein, the programming and/or configuration may vary.

As software, for instance, computer- or machine-readable instructions may be stored on a computer- or machine-readable storage media being executable by one or more processors. In one implementation, instructions may reside in a tangible memory device which may include, for example, any non-volatile electronic memory device (e.g., flash memory, EEPROM, etc.) or other memory device (e.g., disk drive, hard disk drive, writable optical disk, etc.) for storing electronic data. Alternatively or additionally, software may be a stand-alone application running on a computer, for example, through a remote network connection, or via the computer- or machine-readable storage media. In some implementations, the software may be a “plug-in” application that is incorporated into a third-party software application. Other configurations may be also implemented.

The portal or network interface module 231 may be configured to enable the data interchange system 230 to connect to the network 220. This enables the data interchange system 230 to transmit and receive medical device information via the network 230. The network interface module 231, for instance, may be configured to enable TCP/IP protocol, non-TCP/IP protocols or other network protocol(s). It may also be an application programming interface (API) to enable software interaction. As such, the data interchange system 230 may be in communication with the client terminal device 210.

The transaction queue module 232 may be configured to receive medical device information and to prepare the received data for further processing. As data is received it may be placed in an electronic log that may be stored, in an electronic memory. Entries into the log may be made, as they are received, and/or according to some other parameters as may be desired.

The business rules module 233 may be configured to define and maintain adherence to one or more business rules of the system 200. The business rules define which system or systems that data interchange system 230 will direct medical device information to within the system 200. Such rules may include, for example, directing medical device information to the proper system or based on an event that occurs which processes are required to execute.

These rules may be automated to help ensure that one or more stakeholders of system 200 better achieve goals, communicate among principals and agents, communicate between the organization and third parties (e.g., governmental agencies), demonstrate fulfillment of legal obligations, operate more efficiently, automate operations, perform analysis on current practices, etc. The business rules module 233 may ensure that all medical device information necessary for a given transaction has been entered. For example, a non-complying transaction may automatically generate alerts, request additional data, or forward information to an individual to follow-up. In some embodiments, the business rules module 233 may automatically address non-compliant data. This may include entering default parameters.

The notifications module 234 may be configured to provide messaging between the various components of system 200. For example, the notification module 234 enables messaging between the client terminals 210, the data interchange system 230, the clinical site backend system 240, the device manufacturer backend system 250, and/or other machines in the system 200. Messages may be user-initiated, automatically generated, or both. In some instances, the messages may use, for example, Simple Mail Transfer Protocol (SMTP), Post Office Protocol (POP) including POP2 or POP3, Internet Message Access Protocol (IMAP) or others. Notifications can notify any user of the system or data. They may also notify one or more of the systems involved in the processing (as discussed herein).

The interface module 235 may be configured to enable the data interchange system 230 to interface with each of the clinical site backend system 240 and the device manufacturer backend system 250.

The data transfer module 236 may be configured to enable the transfer of medical device information between the data interchange system 230 to interface with each of the clinical site backend system 240 and the device manufacturer backend system 250.

Referring again to FIG. 2, the data interchange system 230 may also make information available to one or more clinical site backend systems 240 and medical device manufacturer backend systems 250. The clinical site backend systems 240 and/or medical device manufacturer backend systems 250 may be directly connected to the data interchange system 230, although it will be appreciated that they may be remote from the data interchange system 230 communicating thereto, for instance, via network 220.

Each clinical site 140 may have its own backend system 240. For ease of clarity, only one clinical site backend system 240 is shown. The clinical site backend system 240 may include one or more systems which a clinical site 140 relies upon for operations. These may include, but are not limited to: an enterprise resource planning (ERP) system 242 and an electronic medical record (EMR) system 244. In some implementations, these may be database systems including software applications for managing data. Other systems are also possible, and different clinical sites 140 may have differently configured backend systems 240. One or more of the systems may be combined. For some implementations, not all systems may be necessary. Each of systems 242 and 244 may have access to and be able to communicate and transfer information with the data interchange system 230.

The ERP system 242 may be configured to provide, among other things, secure patient billing, payment handling, and interfacing with insurance companies, supply chain management, medical device inventory, order entry, scheduling, human resource (employee) management, etc. The ERP system 242 might already be in place at the clinical site 140. The ERP system may be configured to provide payments to the medical device manufacturer 150 for the medical devices 110 that it purchases and/or uses. In one implementation, the ERP system 242 may electronically receive invoices from the medical device manufacturers 150, and generate payment requests to satisfy said invoices. Payments may be made, for instance, electronically.

In addition, the ERP system 242 may be configured to provide inventory reordering. As inventory is used, and/or consumed, requests for medical devices may be generated and transmitted to the medical device manufacturer 140. In some instances, requests might be made by health care providers, or in an automated manner (e.g., when inventory drops below a certain level).

The EMR system 244 may be configured to store and manage electronic medical records for patients 120 of the healthcare providers 130 at the clinical site 140. The storage may comprise a single storage device or multiple storage devices that are distributed across geographically diverse locations. Each patient 120 may have his or her own EMR. An EMR may include, for example, individual health records for that patient, including, a patient identity information (such as name and/or social security number), and records of office visits, patients' vitals, healthcare provider annotations, and other information typically stored in medical records. In some embodiments, capturing patient information may include reading a bar code formed on a wristband attached to a patient's wrist, and in response to reading the barcode, retrieving patient data from the EMR system 244.

Access to patients' records may be limited to authorized health care providers. The EMR system 244 may automatically update patients' records based on the occurrence of an event. This might include, for instance, an office visit, surgery, health care provider's annotation, etc. According to an aspect of the disclosure, medical device information may be further appended to a patient's EMR.

The medical device manufacturer 150 may also have it own backend system 250. The device manufacturer backend system 250 may include one or more systems which the medical device manufacturer 150 relies upon for operations. These may include, but are not limited to: a billing and payment system 251, a device registration system 252 a returns system 253, a complaints system 254, a warranty system 255, a patient management services system 256, a clinical reporting system 257, and a software updates system 258. In some implementations, these may be database systems. Other system architectures are also possible. One or more of the systems may be combined. For some implementations, not all systems may be necessary. Each of systems 251-258 may have access and be able to communicate and transfer with the data interchange system 230.

The secure billing and payment system 251 may be configured to process purchases of medical devices from the medical device manufacturer. The billing and payment system 251 may generate invoices for purchase requests. These may come from health care providers 130 and/or clinical sites 140. Requests might also be made by sales representative and agents of the medical device manufacturer (or perhaps even patients directly). An authentication may be required of the users accessing the system 251. In one implementation, secure billing and payment system 251 may incorporate SAP® business management software. For instance, the billing and payments systems 251 may receive requests electronically via the data interchange system 230. In one implementation, invoices may be electronically generated and transmitted to the clinical site 140 via the data interchange system 230 in response to purchase requests. In addition, the billing and payment system 251 may process payments received from health care providers 130 and/or clinical site 140. Payments may be received electronically.

The device registration system 252 may be configured to register medical devices which are sold or otherwise supplied to heath care providers 130 and/or clinical sites 140. Each medical device may be separately registered. Registered information may include, but is not limited to, the device name (or code correspond thereto), device serial number, patient identifying information, healthcare provider identifying information, clinical site identifying information, and/or other information regarding that medical device.

The returns system 253 may be configured to track and manage product returns. When used medical devices are returned to the device manufacturer they may be logged. This may occur, for instance, because a medical device is defective, no longer operational, or the medical device has been replaced. Each medical device returned to the medical device manufacture may be logged by device name (or corresponding code), device serial number, reason for the return, patient identifying information, healthcare provider identifying information, clinical site identifying information, and/or other information. Depending on the nature of the return, additional analysis or evaluation of the returned device may be performed by (or on behalf) of the medical device manufacturer. This may be to determine the defect, satisfy regulatory requirements, to improve product development, etc. The returns system 253 may track the status of all returns, and disposition of any follow-up action.

The complaint/comment system 254 may be configured to track and monitor complaints and comments regarding medical devices. Complaints and comments may be received by various means, for instances, by mail, email, telephone, via a website, clinical site backend system 240, a client terminal device 210, etc. Each may be logged by device name (or corresponding code), device serial number, reason for the complaint/comments, patient identifying information, healthcare provider identifying information, clinical site identifying information, date the complaint was made, and/or other information.

The warranty claim system 255 may be configured to handle warranty claims for medical devices by the medical device manufacturer. Medical devices typically are covered under a warranty from the device manufacturer. The warranty dictates the terms and conditions for use of the device, duration of warranty, damages, and/or reimbursements and replacement, which are covered by the device manufacture. The warranty information may vary from device to device based on that particular device, its anticipated use, and/or as the terms of the warranty may dictate. Warranty claim processing may involve requesting a warranty credit, reimbursement or replacement for a medical device from the medical device manufacturer. Such requests may be prompted when a medical device is not properly working (e.g., it is broken), and/or it is defective. Each warranty claim received by the medical device manufacturer may be logged by device name (or corresponding code), device serial number, reason for the return, patient identifying information, healthcare provider identifying information, clinical site identifying information, date transferred to patient, date returned to medical device manufacturer, and/or other information.

The patient management services system 256 may be configured to enroll patients 120 in one more patient management services offered by the medical device manufacturer 150 (or a third party). Patient management services may includes programs for monitoring or tracking medical devices used by patients. Such programs may include, for example, Medtronic Inc.'s Paceart® and CareLink® Paceart® is a program which organizes and archives data for cardiac devices across manufactures and serves as a central repository for a patient's arrhythmia information. The Paceart® System serves as a gateway through which data flows from programmers and remote monitoring systems to a clinic's electronic health record (EHR) system.

CareLink® is a program which connects cardiac device patients to their clinic from home or away. Clinicians have 24/7 access via a secure Internet website to a wide range of trended reports offering information comparable to an in-office visit.

Enrollment in patient management service may require, for example, a patient name, device name (or corresponding code), device serial number, patient identifying information, healthcare provider identifying information, clinical site identifying information, date patient received the medical device, enrollment date, and/or other information. Access to the programs may be authenticated to ensure that patient privacy is guarded.

Information for the patient management services system 256 may come from the electronic medical records (EMR)/ERP system provided by a clinical site 240. The EMR and ERP may also securely provide information for returns, warranty services, device registration, and other services provided by the medical device manufacturer's backend. The sharing of data may eliminate redundant data entry and would enable the data interchange system to leverage data previously entered or collected for the EMR/ERP system. The data may be used to populate, for example, a patient's name, birthday, height, weight, medical data, and other information. In one embodiment, a workflow management system may be provided at a clinical site to manage patient care and collect patient data. The workflow management may be able to manage data related to the operation of devices and data related to patients. The workflow management system would ensure that procedures and therapies, such as surgeries, follow-up procedures, diagnostics, physical therapy, and administration of medicine follow prescribed procedures. The workflow management system may be able to notify hospital personnel of past due or incomplete procedures. Data may be collected via the workflow management system, which may track data collected by RFID tags contained in patient wrist bands or which may prompt entry of medical data. The workflow management system would enable medical device data exchange, patient location tracking, and therapy scheduling. The workflow management may be performed in the context of medical care, clinical studies, or some other medical context.

At the medical device manufacturer's backend system, the clinical reporting system 257 may be configured to receive information regarding clinical studies involving medical devices. This information may be stored and/or reported to a government agency, such as the FDA.

The software update system 258 may be configured to track the versions of software running the client terminal devices 210. As new software becomes available, the software update system 258 may make the transmit updates to the client terminal devices 210. The software update system 258 may be updated to reflect the currently versions of software on each and every client terminal device 210. Another function of software update system 258 is to send notification back to the medical device manufacturer 150 of the upgrade status, version installed, location of the client terminal device, and potentially other tracking data, as needed

FIG. 3 illustrates an exemplary client terminal device 300 in accordance with an embodiment of the present invention.

Client terminal device 300 may include one or more modules, including, but not limited to: a processor 310, memory 320, a network interface(s) 330, communication device(s) 340, telemetry systems 350, and user input/output (I/O) peripherals 360. A docking station 370 may optionally be provided which the client terminal device 300 may be removable placed. One or more of the modules may be combined. For some implementations, not all modules may be necessary.

In one implementation, the client terminal device 300 may be configured as a portable, handheld device. For instance, the client terminal device 300 may be a palm-sized, tablet-sized, or notebook-sized device.

A housing 305 may be included that integrates the various modules which comprise each client terminal device 300. The housing may be constructed in or one more pieces of an impact-resistant material, such as, for example, metal, plastic, or both. One or more fasteners, such as, for example, screws, may be used to assemble the housing 305. The housing 305 may optionally include a handle for the convenience of users for holding or transporting the client terminal device 300. In some implementations, the housing 305 may include an internal chassis to modularly mount the various components. Housing may also include a power supply (not shown). This might include a plug, battery pack, transformer, AC/DC convertor, or the like, for providing power to the client terminal device 300.

The processor 310 may include one or more processing devices. For example, the processor 310 may include a dedicated module, such as, a microprocessor, central a processing unit (CPU), or an integrated circuit. In some implementations, the processor 310 may be may include hardware (such as, an application specific integrated circuit (ASIC) or field programmable gate array (FPGA)), software (firmware), or a combination of hardware and software for executing machine- or computer-implemented instructions. The processor 310 may be configured to execute an operating system and one or more applications. In some instance, the processor 310 may include a clock module for automatically generating date/time data associated with an event.

The memory 320 may be configured to store read-readable instructions for operating the client terminal device. Such instructions may include an operating system, and one or more applications. In additional, the memory device may be configured to store other data, collected, received and/or transmitted temporarily, and/or permanently. The instructions may be configured as hardware, software (e.g., firmware), or combinations therefore. The memory 320 may include, for example, any non-volatile electronic memory device (e.g., flash memory, EEPROM, etc.) or other memory device (e.g., disk drive, writable optical disk, etc.) for storing electronic data. Memory 320 may be removable and/or couple to an interface, such as, for example, a USB port, RS-232 port, parallel or serial port, or other connector or jack, for interfacing and communicating data.

The network interface 330 may be configured to enable the client terminal device 300 to connect to, and transmit data with one or more networks. This may include one or more physical connections (e.g., jacks) for connecting to wired networks. For wireless communication, one or more of antennas may be provided for transmitting and receiving electromagnetic energy wirelessly. Alternatively or additionally, optical transmission may also be used, including, for instance, an infrared (IR) communicator device (e.g., according to the IrDA specification). In some implementations, the network interface module 320 may be configured for WiFi (IEEE 802.11), WiMax (IEEE 802.16), cellular (e.g., 0G, 1G, 2G, 3G, 4G, etc.), standard telephony networks, and/or other wireless access technologies and standards.

The communication device 340 may be configured to scan and/or collect information and data from one or more sources in an automated manner. The sources may include the medical device (and/or packaging thereof), patient medical records, billing records, or other source. The communication device module 340 may include one or more of devices for reading machine-readable indicia, such as, a bar-code reader, a radio-frequency identification (RFID) tag reader, magnetic strip reader, smart card reader, etc. Also, communication device module 340 may include a biometric reader (e.g., fingerprint, facial recognition, iris recognition, DNA, etc.) automated voice recognition device, scanner, camera, or other device for capturing information. One or more algorithms may be applied to captured data. This may include, for instance, optical character recognition (OCR) for converting scanned images to text, speech recognition for converting sound to text, decoding barcodes, etc. The step of capturing data with a communication device module, as used herein, may be known as a “scanning”

The telemetry system 350 may be configured to interface and/or communicate with one or more medical devices. The telemetry system 350 may transmit information to, and/or receive information from one or more medical devices. This may include wired and/or wireless communications. Different medical devices may have different means for communications. For instance, medical devices implanted inside the body, such as a pacemaker, may only be able to communicate via wireless communications. Other devices, though, may include a connection or jack for wired communications. The telemetry system 350 may be configured to exchange data from the medical device, such as to receive vital signs, and/or to transmit software or configuration instructions to the medical device. Also, the telemetry system 350 may activate or deactivate a medical device. In some instances, the telemetry system module 350 may adopt the ISO/IEEE 11073 Medical/Health Device Communication Standards.

The user I/O peripherals 360 may be one or more input and/or output device configured to enable users to input data, and to view or retrieve data from, the client terminal device 300. Input peripheral devices may include, for instance, one or more of: a keyboard, keypad, mouse, designated function buttons or switches, trackball, stylus, touch screen, touch pad, lighten, microphone, biometrics reader, scanner, bar code and other RFID readers and/or other input devices. Output peripheral devices may include, for instance, one or more of a: display device (e.g., screen or monitor), designated optical indicators (e.g., LEDs, lights, etc.), printing device, speakers, headphone jack, haptic device, projector, and/or other output devices. A single touch screen may, in some instances, be used for both inputting and outputting data.

The docking station 370 may be configured for holding the client terminal device 300. For instance, the client terminal device 300 may have placed in the docking station 370 when not being used. In some implementation, the docking station 370 may provide power and/or data interfacing. The client terminal device 300 may, for instance, be configured to be charged while placed in the docking station 370. Also, the client terminal device 300 and the docking station 370 may have one or more cooperating connectors (e.g., male and/or female jacks), which engage together to facilitate power and/or data transfers.

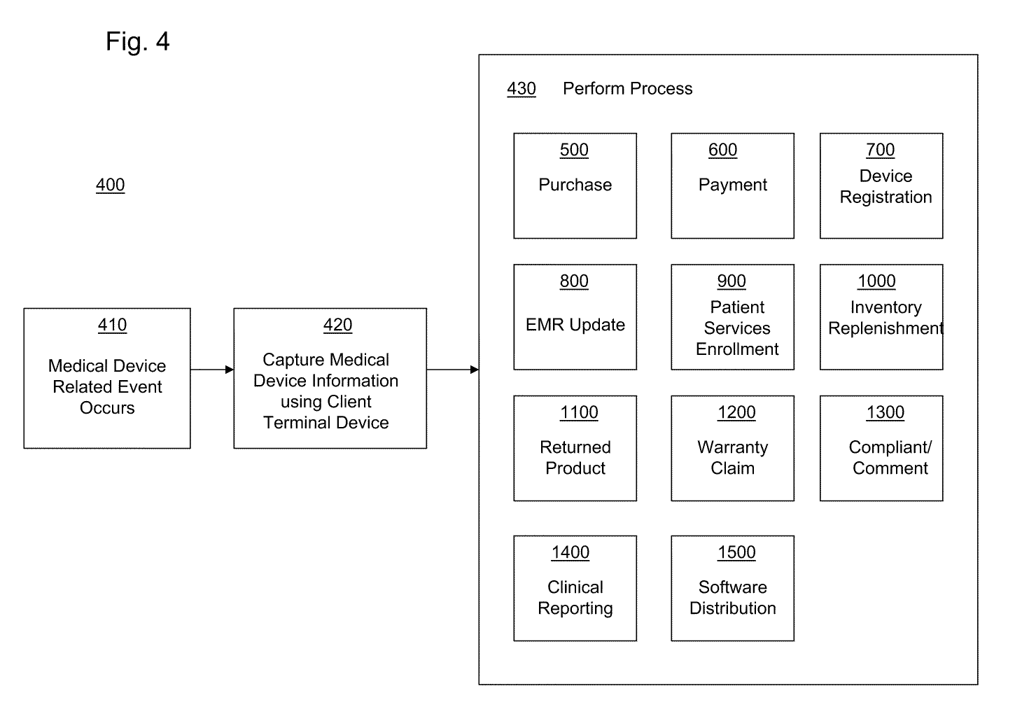

FIG. 4 illustrates an exemplary method 400 for tracking and managing medical devices in accordance with an embodiment of the present invention.

In step 410, a medical device related event occurs. Medical device related events may include, for example, inventory tracking, an implant of a medical device in a patient, an explant (or removal) of a device from a patient, a patient office visit, a clinical study, etc. An event can be triggered by a user of a client terminal device 210. Alternatively or additionally, an event may be automatically triggered, for example, by another system (such as a backend system).

Next, in step 420, one or more client terminal devices 210 capture medical device information, which may be securely transmitted to data interchange device 230. Medical device information may be entered, for instance, using the one or more of the communication device(s) 340, the telemetry system 350, and user I/O peripherals 360 of the client terminal device 300 (FIG. 3). This may include scanning, with a client terminal device 210, a machine-readable indicia, such as, for example, a bar-code, a radio-frequency identification (RFID) tag, magnetic strip, smart card, etc. The machine-readable indicia may be provided on a medical device 110 itself, the packaging thereof, a patient file, a document, etc. Data capture may also include, using the client terminal device 210 to take a biometric reading (e.g., of a fingerprint, face, iris, DNA, etc.), make a voice recoding, etc. These processes may be referred to as “scanning”

In some circumstance, steps 410 and 420 may be reversed, and/or may occur essentially simultaneously. For instance, capturing data using a client terminal device 210 may prompt a medical device related event to occur.

In step 430, in response to a specific event and data capture, one or more processes may be executed, based on the medical device event, from step 420. These processes may include, for instance, purchase process 500, payment process 600, device registration process 700, EMR update process 800, patient services enrollment process 900, inventory replenishment process 1000, returned product process 1100, warranty claim process 1200, complaint/comment process 1300, clinical reporting process 1400, and software distribution process 1500. Other processes may be added, and in some implementation, not all processes may be provided.

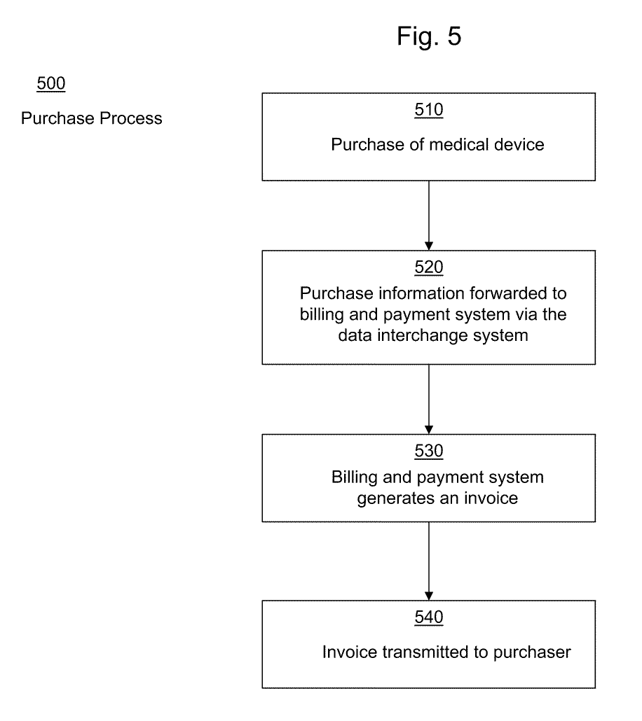

FIGS. 5-16 illustrate exemplary processes 500-1500 in accordance with various embodiments for tracking and managing medical device information.

FIG. 5 illustrates a purchase process 500 in accordance with an embodiment.

The purchase process 500 involves purchasing one or more medical devices from the medical device manufacturer. The purchaser may be a clinical site (although, it will be appreciated that health care providers and/or patients could also purchase medical devices) from the medical device manufacturer. In some instance, a sales representative of the medical device manufacturer could help facilitate a purchase, as well. Sales representatives may, in some instances, operate remotely from clinical sites 140, such as, for example, via telephone, fax, email, mail, etc.

In step 510, a purchase for one or more medical devices from the medical device manufacturer may be initiated by the purchaser via the data interchange system 230. The purchaser may do so, for instance, via a clinical site backend system 240 and/or a client terminal site 210. For instance, this may include using user I/O peripherals 360 of the client terminal device 300 (FIG. 3). Alternatively or additionally, purchases might also be made through a website in communication with the data interchange system 230. Other purchasing means can also be used (such as by mail, email, facsimile, sales representative, etc.). Purchase order information may be collected at this time. This may include, for instance, the specific medical device(s) to purchase, shipping information, billing information, invoice number, balance, tracking numbers, etc. Purchases may include one of a sale upon shipping and a sale upon implant.

Next, in step 520, the data interchange system 230 forwards the purchase order to the billing and payment system 251 of the medical device manufacturer backend system 250. In step 530, the billing and payment system 251 generates an invoice for the purchaser. The invoice indicates the outstanding balance due for the purchaser. The purchaser may have an account with the medical device manufacturer. If not, a new account may be created.

In step 540, the invoice may be transmitted to the purchaser. In one implementation, the invoice may be generated by the billing and payment system 251 electronically and sent to the ERP system 242 of the clinical site backend system via the data interchange system 230. Otherwise, the invoice may be generated and sent to the purchaser, for instance, by mail, email, facsimile, etc.

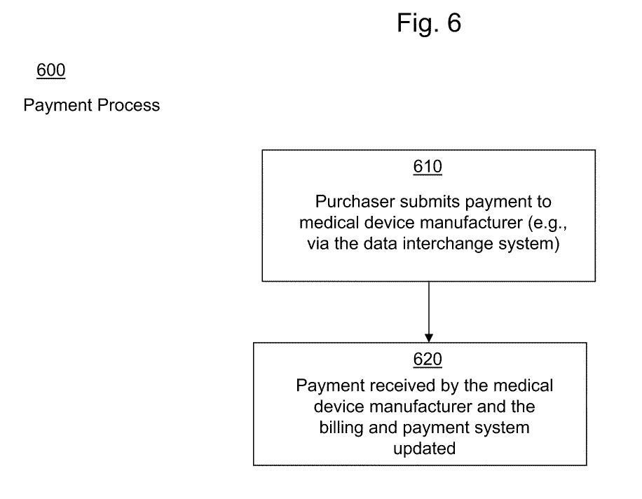

FIG. 6 illustrates a payment process 600 in accordance with an embodiment of the present invention. The payment process includes collecting payment from a purchaser of a medical device. The purchase process 500 may have occurred in advance and an invoice for a purchase has already been generated.

In step 610, upon receipt of the invoice, the purchaser can submit payment to the medical device manufacturer. Payment information can sent to the device manufacturer according to the payment terms. This may include, for instance, the invoice number, payment amount, account numbers, tracking numbers, or other data necessary to facilitate a payment transaction.

Payments may be electronically or through physical means, such as a check, money order, etc. The payment may be submitted electronically by the ERP system 241 of the clinical site backend system 240. In one instance, payments may be transmitted to the billing and payment system 251 of the medical manufacturer backend system 250 via the data interchange system 230. In step 620, when payment is received by the medical device manufacturer the invoice may be satisfied, and the outstanding balance closed.

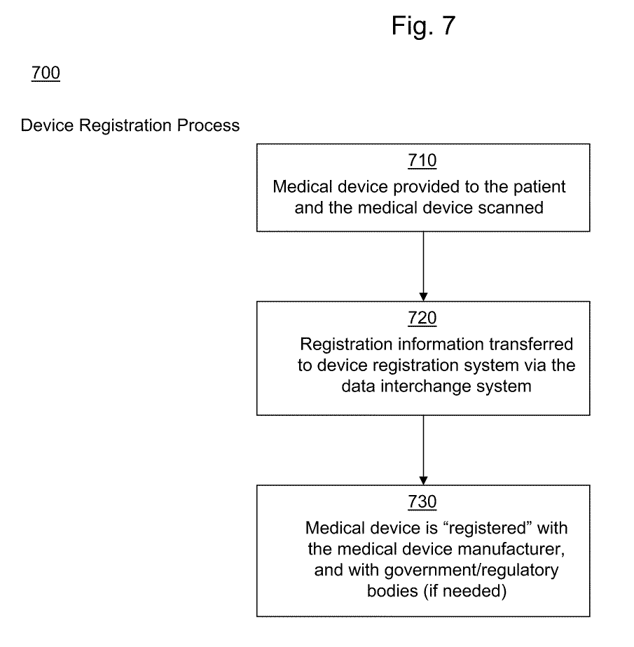

FIG. 7 illustrates a device registration process 700 in accordance with an embodiment of the present invention.

Device registration is a process notifying the medical device manufacturer when a medical device is implanted or otherwise used, for instance, by a patient (rather than being mere inventory at the clinical site).

In step 710, a medical device may be provided to a patient. In some instance, the medical device may require implantation in the patient. Thus, an implantation procedure may be performed under the supervision of a health care provider, for instance, at a clinical site. This may include outpatient surgery, or even invasive surgery, depending on the particular medical device implanted. The health care provider may activate or deactivate a device, and/or configure (or adjust) parameters of the medical device using the telemetry system 350. One or more configuration parameters of the medical device may be adjusted as necessary (depending on the particular medical device). This enables the customizable treatment for the patient. In some instances, configuration information may be retrieved, for instance, via the data interchange device 230 from the medical device manufacturer backend system.

At around this time, the medical device (or packaging thereof) may be scanned using a client terminal device 210. For instance, this may include using the one or more of the communication device(s) 340, the telemetry system 350, and user I/O peripherals 360 of the client terminal device 300 (FIG. 3).

Scanning the medical device may obtain the following medical device information: device name (or corresponding code), model number, and serial number. In some instances, this may include capturing information directly from the device (or packaging) itself. In other instances, this may include reading a machine-readable indicia and retrieving stored information (e.g., from the medical device manufacturer) corresponding to the indicia. Additional data may be inputted into the client terminal device 210, for instance via the I/O peripherals 360 which was not initially captured by the communication device(s) 340, and/or the telemetry system 350 of the client terminal device. This data may include, for example, patient name, patient contact information, patient's vitals, use or implant date, device configuration parameters (or adjustments), health care providers annotations, etc.

At step 720, medical device information may be transferred to device registration system 252 of the medical device manufacturer backend system 250 via the data interchange system 230. Once entered in step 730, the medical device may be considered “registered” with the device manufacturer. In addition, the medical device manufacturer may register the medical device with one or more government agencies and/or other regulatory bodies (if needed).

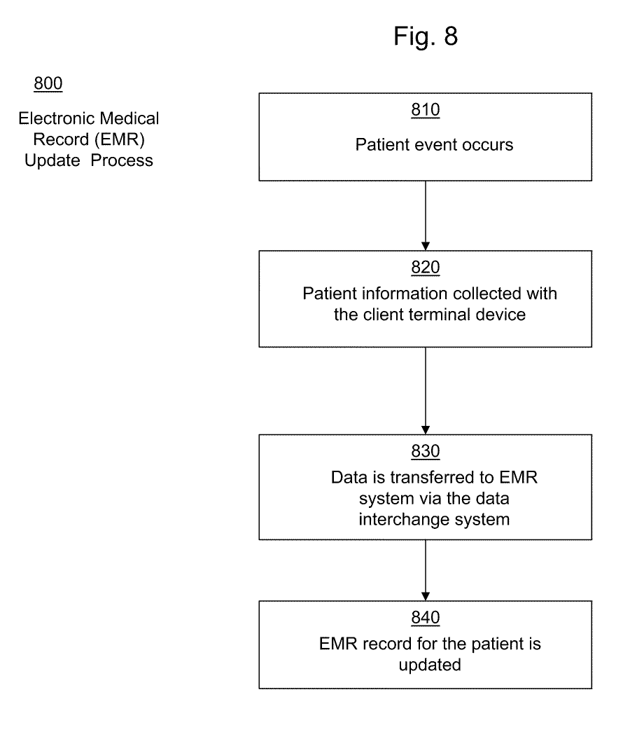

FIG. 8 illustrates an EMR update process 800 in accordance with an embodiment of the present invention.

EMR integration is the process of sharing medical device information with an EMR system 244 of a clinical site backend system 240. This may enable EMR records for patients to be automatically updated. In some embodiments, a client terminal device 210 may be configured to provide patients with instructions, and/or to practice telemedicine. Telemedicine includes transmitting medical information through interactive audio-visual media for the purpose of consulting, and sometimes remote medical procedures or examinations.

In step 810, an event may occur that generates medical device information which may be of interest for the patient. This may include an office visit, a medical examination, testing, laboratory result, implantation, etc.

At step 820, information may be collected using a client terminal device 210. For instance, this may include using the one or more of the communication device(s) 340, the telemetry system 350, and user I/O peripherals 360 of the client terminal device 300 (FIG. 3). The client terminal device 210 may collect medical device information from the medical device and/or patient information. For instance, the telemetry system 350 may be used to record vitals or other information received from the medical device. In addition, configuration parameters (or adjustments) to the medical device may be made using the telemetry system 350. Collected information may include patient name, patient contact information, patient's vitals, use or implant date, device configuration parameters (or adjustments), health care providers annotations, etc.

Additional data may be inputted into the client terminal device 210, for instance, via the I/O peripherals 360 which was not initially captured by the communication device(s) 340 and/or the telemetry system 350 of the client terminal device. This may include health care provider annotations, test or laboratory results, date/time, patient's vitals, etc.

At step 830, data is transferred via the data interchange system 230 to the EMR system 244. And in step 840, the EMR record for the patient may be updated based on the data.

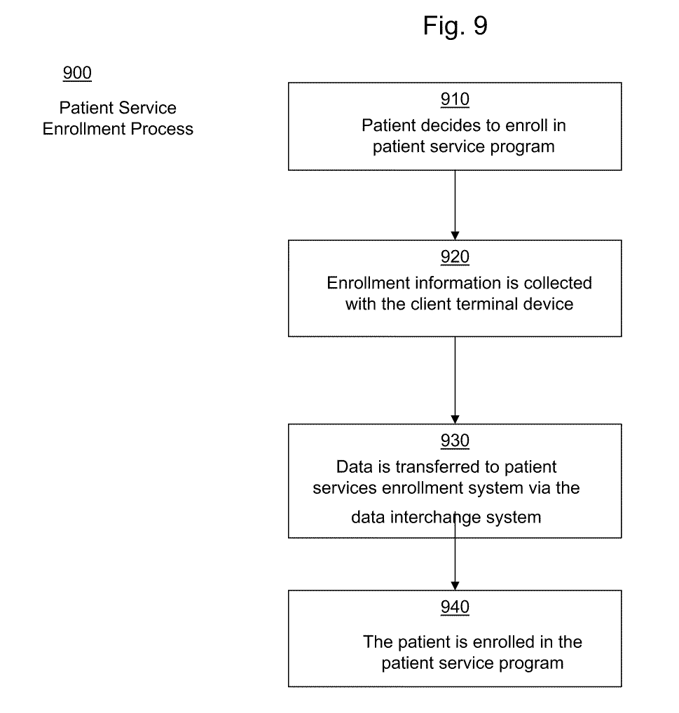

FIG. 9 illustrates a patient services enrollment process 900 in accordance with an embodiment of the present invention.

Patient services enrollment includes enrolling a patient in a service program related to the medical device. Patient management services may includes programs for monitoring or tracking medical devices used by patients. Such programs may include, for example, Medtronic, Inc.'s Paceart® and CareLink® services. Generally, this may occur at around the time the patient has been provided with a particular medical device. For instance, this may occur essentially simultaneously with an implantation process.

Enrollment in patient management service may require, for example, a patient name, device name (or corresponding code), device serial number, patient identifying information, healthcare provider identifying information, clinical site identifying information, date/time patient received the medical device, enrollment date, and/or other information.

First, in step 920, information may be collected using a client terminal device 210. For instance, this may include using the one or more of the communication device(s) 340, the telemetry system 350, and user I/O peripherals 360 of the client terminal device 300 (FIG. 3). The client terminal device 210 may collect medical device information and/or patient information. Additional data may be inputted that was not initially captured by the client terminal device 210. This may include health care provider annotations, test or laboratory results, date/time of receiving device, patient's vitals, etc.

And, in step 930, data is transferred via the data interchange system 230 to the patient services enrolment system 256 of the medical device manufacturer system 250. The patient is electronically enrolled in the patient services program in step 940. If necessary, additional information may be provided to the patient for the particular service enrolled. The patient may then participate in the enrollment program in the ordinary course.

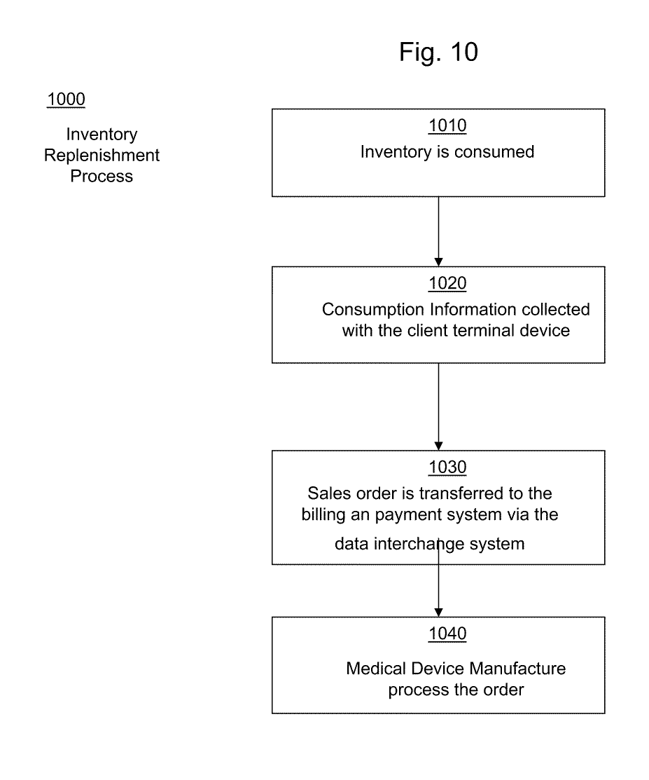

FIG. 10 illustrate an inventory replenishment process 1000 in accordance with an embodiment of the present invention.

Inventory replenishment is the process of tracking consumed inventory and placing order to restore inventory at a clinical site. Clinical sites may choose to enroll in an automated process for inventory restocking. The client terminal devices may be used to set, and/or change inventory par levels for medical devices.

Inventory may be consumed or used at the clinical site in the ordinary course in step 1010. Typically, medical devices may be stored in a supply room or other storage location at the clinical site. As products are removed from inventory, they may be scanned using a client terminal device 210. Scanning the medical device may obtain the following consumption information: device name, model number, serial number, etc.

In step 1020, consumption information may be transmitted to the device manufacturer via the data interchange system 230. Consumption information may include specific medical devices that have been removed from inventory. This information may be transmitted in real-time, or on a batch basis (e.g., hourly, daily, etc.)

Next, in step 1030, sales orders may be automatically created for the clinical site by the device manufacturer using the billing and payment system 251. The sales orders may be generated as consumption information is received or on a batch basis. Continuing to step 1040, the medical device manufacturer processes the order and ships the order to the clinical site. An invoice may be generated similar to the purchase process 500.

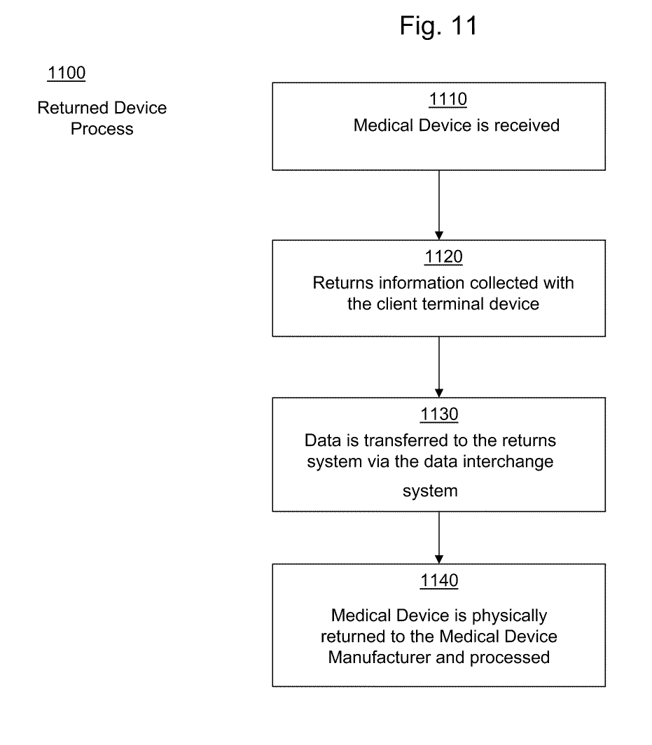

FIG. 11 illustrates a returned device process 1100 in accordance with an embodiment.

Devices may be returned to the medical device manufacturer in the event that a medical device is determined to be no longer in proper working order. Upon receiving devices, the device manufacturer may later analyze the returned product, for instance, to determine defects.

In step 1110, a medical device may be received from the health care provider, sales representative, and/or a patient. In the case that the medical device is implanted in the patient, the medical device may be explanted (or removed) from a patient. The explantation is a medical procedure that occurs under the supervision of a health care provider, for instance, at a clinical site. At around this time, in step 1120 the medical device may be scanned using a client terminal device 210.

Scanning the medical device may obtain one or more of the following medical device information elements: device name, and identification code thereof, model number, and serial number. In some instances, this may include capturing information directly from the device (or packaging) itself. In other instances, this may include reading a machine-readable indicia and retrieving stored information (e.g., from the medical device manufacturer) corresponding to the indicia. Patient information may also be retrieved from the device itself, or from a database of patient information matched to a device's serial number.

Additional data may be input that was not initially captured by the client terminal device 210. This may include, for example, one or more of patient name, patient contact information, patient's vitals, return or explant date, device configuration parameters, health care provider's annotations, etc.

At step 1130, medical device information may be transferred to returns system 253 of the medical device manufacturer backend system 250 via the data interchange system 230.

At step 1140, the medical device may be physically transported back to the device manufacturer. This may occur by shipping or mailing the device to the medical device manufacturer. Once the device is received by the device manufacturer the medical device may be “checked-in.” This may entail scanning of the returned medical device at the device manufacturer, and matching it against entries in the returns system 253. An audit may be performed to ensure that all medical devices which were entered in the return product database have been received and processed.

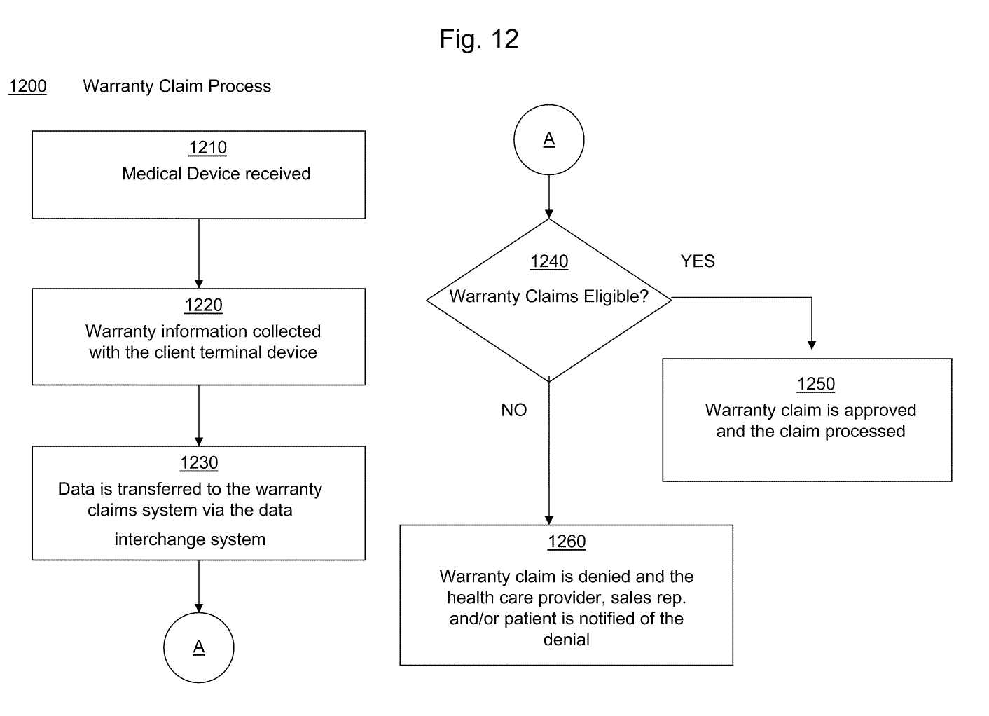

FIG. 12 illustrates a warranty claim process 1200 in accordance with an embodiment of the present invention.

Medical devices typically are covered under a warranty from the device manufacturer. The warranty dictates the terms and conditions for use of the device, duration of warranty, damages, and/or reimbursements and replacement, which are covered by the medical device manufacturer. The warranty information may vary from device to device based on that particular device, its anticipated use, and/or as the terms of the warranty may dictate. Warranty claim processing may involve requesting a warranty credit, reimbursement or replacement for a medical device from the medical device manufacturer. Such requests may be prompted when a medical device is not properly working (e.g., it is broken), and/or it is defective.

First, in step 1210, a medical device may be received from the health care provider, sales representative, and/or a patient. For instance, this may occur if a medical device is determined to be improperly working or defective. Typically, this is determined by a health care provider. If the device is implanted in a patient, the device may need to be removed from the patient under the supervision of a health care provider, for instance, at a clinical site. Additionally, a device could be found to be in a defective condition or improperly working, while in inventory, and/or not implanted in a patient. Diagnostic testing may be used for such purposes.

Next in step 1220, upon determining that the device is improperly working or defective, the device is scanned using a client terminal device 210. Data captured by scanning the medical device may include, among other things, medical device name, identification code thereof, model number, serial number, etc. Additional data may also be entered at this time via the client terminal device 210 which may not have been initially captured. This may include, for example, one or more of patient name, health care provider, clinical site, date/time returned (or explant), reasons given for defect, device configuration parameters (or adjustments), or other information that may be necessary for filing a warranty claim.

In step 1230, the collected data is transmitted via the data interchange system 230 to the warranty claims system 255 of the medical device manufacturer backend system 250.

At step 1240, the device manufacturer reviews the warranty claim for eligibility. Depending on whether the warranty claim was approved or denied in step 1240, the warranty claim is either approved and processed in step 1250, or a notification is generated to notify the health care provider, sales representative, and/or patient of the denial in step 1260. Warranty processing in step 1250 may be handling in the ordinary course. Notification may be made by various means, such as, via mail, electronic mail, data interchange system 230, client terminal device 210, etc.

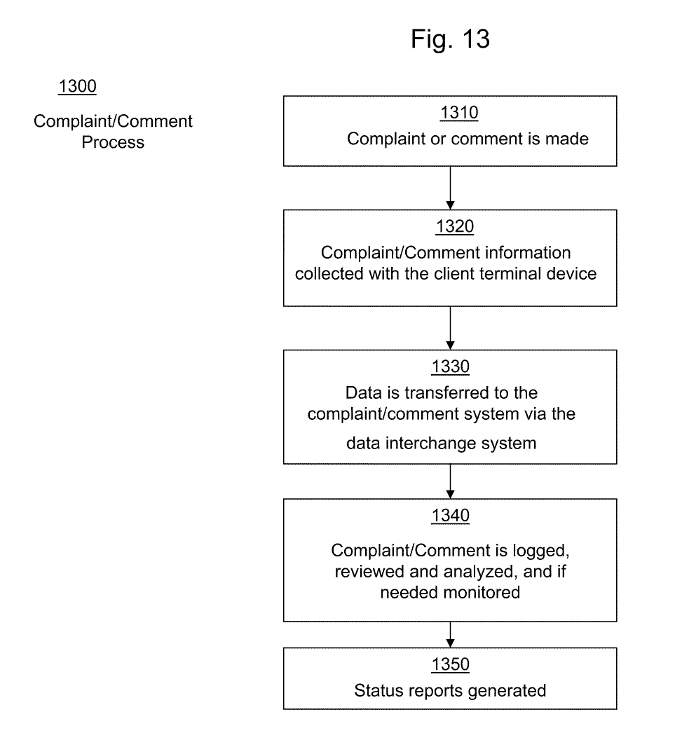

FIG. 13 illustrates a complaint/comment process 1300 in accordance with an embodiment of the present invention.

Comments and complaints may be received by the device manufacturer. The comments and complaints may be investigated by the device manufacturer as desired.

First, in step 1310, a comment or complaint is made by a patient and/or health care provider. Next, step 1320, complaint/comment information may be input via client terminal device 210, and electronically submitted to the complaint/comment system 254 via the data interchange system 230 to the device manufacturer in step 1330.

Complaint/comment information may include, for example, one or more of: medical device name, identification code thereof, model number, serial number, date/time of complaint/comments, the particulars of the complaint or comments, health care provider, clinical site, etc.

At the medical device manufacturer, complaints are logged in complaints/comments system 254 of the medical device manufacturer backend system 250.

In step 1340, the status of logged comments and complaints may be monitored by the medical device manufacturer. For instance, comments and complaints may be reviewed and analyzed by the medical device manufacturer to determine product compliance issues and/or improvements. If needed, complaint and comments may require further monitoring, and update. For example, complaint/comments may be monitored to detect trends, or problems, related to one or more medical devices. Once an investigation is completed, the status of any logged comment of complaint may be marked and completed. In step 1350, reports may be generated for the status of all pending complaint and comments.

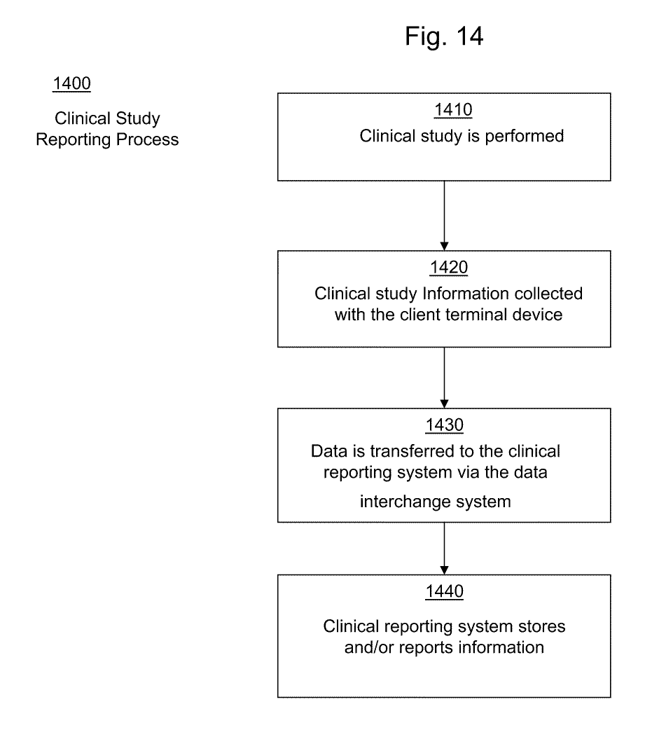

FIG. 14 illustrates a clinical reporting process 1400 in accordance with an embodiment of the present invention.

Clinical reporting is the process of reporting clinical data to the medical device manufacturer for clinical study analysis.

Clinical studies may be performed in step 1410. These clinical trails may be conducted to evaluate the performance and safety of medical devices. In step 1420, information may be collected using a client terminal device 210. For instance, this may include using the one or more of the communication device(s) 340, the telemetry system 350, and user I/O peripherals 360 of the client terminal device 300 (FIG. 3). The client terminal device 210 may collect medical device information and/or patient information. Collected information may include, for example, one or more of: patient name, patient contact information, patient's vitals, device configuration parameters, health care provider's annotations, etc. Additional data may be inputted that was not initially captured by the client terminal device 210. This may include one or more of: additional health care provider annotation, test or laboratory results, date/time, patient's vitals, etc.

And, in step 1430, data is transferred to the clinical reporting system 257 via the data interchange system 230. The medical device manufacturer may store information in the clinical reporting system 257 and/or reported to a government agency, such as the FDA.

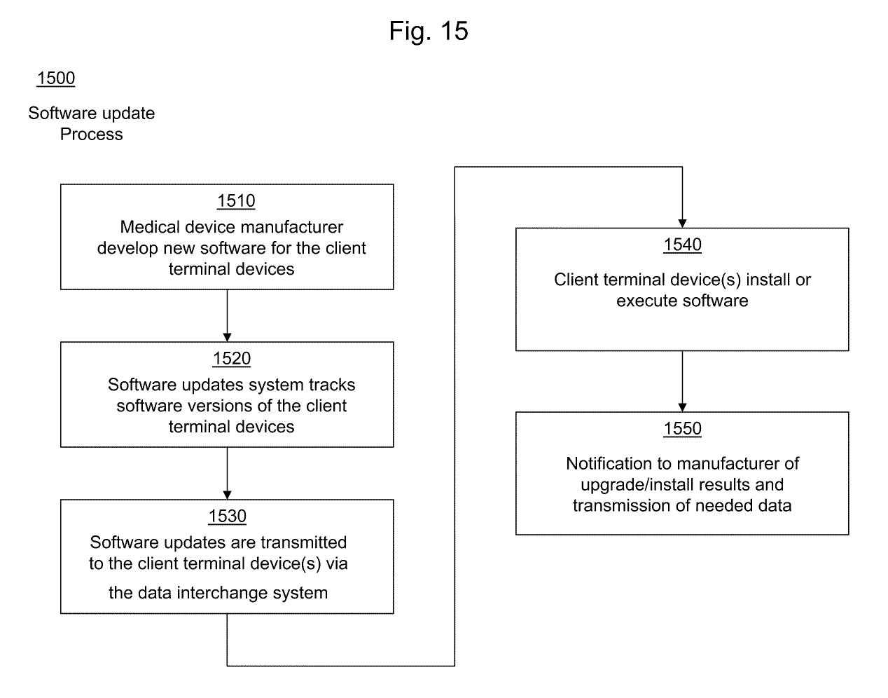

FIG. 15 illustrates a software distribution process 1500 in accordance with an embodiment of the present invention.

Software distribution is the process of updating the software for one or more client terminal device 210. The software may include, for instance, software or productivity software.

In step 1510, the medical device manufacturer (or its agents) may develop new software updates and applications. This may include a new version, upgraded version, modification and/or “patches.”

Alternatively or additionally, in step 1520, a customer may request a software update via the data interchange system 230. This may include requests to solve problems or fix “bugs” associated with the software. The software updates system 258 may include information regarding the software versions of one or more of the client terminal devices 210.

Next, in step 1530, the medical device manufacturer transmits the new software to client terminal devices 210 via the data interchange system 230. This may occur as updates become available (or on a scheduled basis) or as requested.

In step 1540, upon receipt of the software upgrade, the client terminal 210 installs or executes the software update. And, in step 1550, the medical device manufacturer is notified of the upgrade/install results and transmission of needed data. The software updates system 258 to reflect the software versions installed or executed on one or more of the client terminal devices 210.

Other processes may similarly be provided by the system 200 and the method 400. Accordingly, improved systems and methods for managing medical device and patient information may be realized.

While the description above is related generally to medical device manufacturers and/or clinical sites, it will be appreciated that the disclosures in application may be adapted to other industries and organizations. As such, recitations of medical device manufacturers and/or clinical sites are not intended to be limiting.

Other embodiments, uses and advantages of the inventive concept will be apparent to those skilled in the art from consideration of the above disclosure and the following claims. The specification should be considered non-limiting and exemplary only, and the scope of the inventive concept is accordingly intended to be limited only by the scope of the following claims.

What is claimed is:

1. A system for managing devices, comprising:
a data interchange interface configured to receive a medical device inventory transaction from one or more remote clinical sites, the data interchange interface comprising a first set of one or more processing devices configured to execute:
a business rules module configured to determine whether data in the medical device inventory transaction is complete, and
a data transfer module configured to forward the medical device inventory transaction to a computing device; and
a medical device management system configured to receive the medical device inventory transaction from the data transfer module, the medical device management system comprising a second set of one or more processing devices configured to execute:
a device purchase module configured identify from the medical device inventory transaction a purchase request, configured to generate a purchase invoice based on the transaction, and configured to transmit the invoice to the data interchange interface.

2. The system of claim 1, wherein the second set of one or more processing devices is further configured to execute:
a device registration module configured to identify from the medical device inventory transaction a medical device identification value and a health care provider identification value, and configured to associate the medical device identification value with the health care provider identification value in a device registration database.

3. The system of claim 1, wherein the second set of one or more processing devices is further configured to execute:
a device comment module configured to identify from the medical device inventory transaction a medical device identification value and one or more comments related to a medical device having the medical device identification value, and configured to associate the one or more comments with the medical device identification value in a device comments database.

4. The system of claim 1, wherein the second set of one or more processing devices is further configured to execute:
a device returns module configured to identify from the medical device inventory transaction a device returns request or a device exchange request, a medical device identification value associated with the request, and a health care provider identification value associated with the request, and configured to update the device registration database based on the device returns request or the device exchange request.

5. The system of claim 1, wherein the second set of one or more processing devices is further configured to execute:
a warranty claims module configured to identify from the medical device inventory transaction a warranty claims request, a medical device identification value associated with the warranty claims request, and data relating to device defects, and configured to associate the medical device identification value with the data in a warranty claims database.

6. A system for managing devices, comprising:
a data interchange interface configured to receive a patient device management transaction from one or more remote sites, the data interchange interface comprising a first set of one or more processing devices configured to execute:
a business rules module that determines whether data in the patient device management transaction is complete, and
a data transfer module configured to forward the patient device management transaction to a computing device; and
a medical device management system configured to receive the patient device management transaction from the data transfer module, the medical device management system comprising a second set of one or more processing devices configured to execute:
a patient management services module configured to identify from the patient device management transaction a patient identification value and a patient device identification value, and configured to associate the patient identification value with the patient device identification value in a patient management database.

7. The system of claim 6, wherein the patient management services module is further configured to identify from the patient device management transaction a physiological measurement measured by a patient device having the patient device identification value, and configured to associate the patient identification value with the physiological measurement in the patient management database.

8. The system of claim 6, wherein the second set of one or more processing devices is further configured to execute:
a clinical reporting module configured to identify from the patient device management transaction a clinical test identification value and a regulatory agency identification value, and configured to forward the regulatory agency identification value to the data interchange interface, and
wherein the data transfer module is further configured to transmit clinical test results to an agency site having the regulatory agency identification value.

9. A system for managing devices, comprising:
a medical device management system comprising a second set of one or more processing devices configured to execute:
a software update module configured to receive a software update or a firmware update and configured to identify from the software update or firmware update a medical device identification value associated with the update; and
a data interchange interface configured to receive, from the management device management system, the software update or firmware update and the medical device identification value associated with the update, and configured to transmit the software update to a remote medical device having the medical device identification value.

10. A method for managing devices, comprising:
receiving, at a data interchange interface, a medical device inventory transaction from one or more remote clinical sites;
determining, at the data interchange interface, whether data in the medical device inventory transaction is complete;
forwarding, at the data interchange interface, the medical device inventory transaction to a computing device;
receiving, from the computing device, a purchase invoice generated based on the forwarded medical device inventory transaction, wherein the medical device inventory transaction identifies a medical device identification value and a health care provider identification value.

11. The method of claim 10, further comprising identifying from the medical device inventory transaction one or more comments related to a medical device having the medical device identification value; and
associating the one or more comments with the medical device identification value in a device comments database.

12. The method of claim 10, further comprising
identifying from the medical device inventory transaction a device returns request or a device exchange request, a medical device identification value associated with the request, and a health care provider identification value associated with the request; and
updating a device registration database based on the device returns request or the device exchange request.

13. The method of claim 10, further comprising:
identifying from the medical device inventory transaction a warranty claims request, a medical device identification value associated with the warranty claims request, and data relating to device defects; and
associating the medical device identification value with the data in a warranty claims database.

14. A method for managing devices, comprising:
receiving, at a data interchange interface, a patient device management transaction from one or more remote sites;
determining, at the data interchange interface, whether data in the patient device management transaction is complete;
forwarding the patient device management transaction to a computing device;
identifying from the patient device management transaction a patient identification value and a patient device identification value;
associating the patient identification value with the patient device identification value in a patient management database.

15. The method of claim 14, further comprising:
identifying from the patient device management transaction a physiological measurement measured by a patient device having the patient device identification value; and
associating the patient identification value with the physiological measurement in the patient management database.

16. The method of claim 15, further comprising:
identifying from the patient device management transaction a clinical test identification value and a regulatory agency identification value;
forwarding the regulatory agency identification value to the platform interchange interface; and
transmitting clinical test results to an agency site having the regulatory agency identification value.

17. A device, comprising a transceiver configured to communicate with a data interchange interface, wherein the data comprises information on a medical device inventory transaction, the medical device inventory transaction comprising device purchase information, device registration information, device comment information, or any combination thereof.

18. The device of claim 17, wherein the medical device inventory transaction further comprises device returns information, warranty claims information, or any combination thereof.

19. The device of claim 18, wherein the medical device inventory transaction further comprises patient management information.

20. The device of claim 16, wherein the transceiver is configured to communicate with an electronic medical records system.
